(19) United States
(12) Patent Application Publication
(10) Pub. No.: US 2024/0332490 A1
(43) Pub. Date: Oct. 3, 2024

(54) BATTERY ELECTRODE AND MANUFACTURE THEREOF

(71) Applicant: Rivian IP Holdings, LLC, Plymouth, MI (US)

(72) Inventors: Ki Tae Park, Santa Clara, CA (US); Soo Kim, Fremont, CA (US); Hyuk Sang Park, San Jose, CA (US); Meng Wang, Pleasanton, CA (US); Harold Tan Dimagiba, Fremont, CA (US)

(21) Appl. No.: 18/190,615

(22) Filed: Mar. 27, 2023

(51) Int. Cl. H01M 4/04

(52) U.S. Cl. CPC H01M 4/0435; H01M 2004/021

(57) ABSTRACT

A battery electrode and manufacture thereof is provided. A system can include a first roller including a first surface comprising a pattern to form a patterned surface on an electrode foil. The system can include the first roller to deform the electrode foil to create the patterned surface on the electrode foil with at least a portion of the electrode foil disposed between the first surface of the first roller and a second surface. The second surface can be configured to support the electrode foil.

### INTRODUCTION

A battery can be used to operate a vehicle or components thereof.

### SUMMARY

The present disclosure relates to battery electrodes and the manufacture thereof. For example, this technical solution can be directed to deforming an uncoated portion of an electrode foil of an electrode to create a pattern or texture. A system can deform the uncoated portion of the electrode foil to increase a bending stiffness thereof, for example. The system can include a roller having a patterned element with a patterned surface. The pattered surface of the patterned element can contact an uncoated portion of an electrode web and apply a force or pressure to the uncoated portion. The patterned surface of the patterned element can deform the uncoated portion to create at least one deformation of the uncoated portion. The deformation can increase a bending stiffness of the uncoated portion or can alter an area moment of inertia of the uncoated portion to improve a rigidity of the uncoated portion. The disclosed solutions have a technical advantage of increasing the stiffness or rigidity of the uncoated portion such that the uncoated portion is less susceptible to bending, creasing, folding, or other damage as the electrode web is processed to manufacture electrodes. For example, the uncoated portion can be subject to gravitational forces, among others, during manufacture of an electrode web or an electrode, where the forces can cause the uncoated portion to sag, bend, hang, droop, or otherwise flex, which can lead to the uncoated portion becoming inadvertently creased, folded, crimped, or damaged.

At least one aspect is directed to a system. The system can include a first roller including a first surface comprising a pattern to form a patterned surface on an electrode foil. The system can include the first roller to deform the electrode foil to create the patterned surface on the electrode foil with at least a portion of the electrode foil disposed between the first surface of the first roller and a second surface. The second surface can be configured to support the electrode foil.

At least one aspect is directed to a method. The method can include providing an electrode foil for a battery to one or more rollers having a first surface comprising a pattern to form a patterned surface on an electrode foil. The method can include deforming, by the one or more rollers, at least a portion of the electrode foil to create the patterned surface on the electrode foil. The method can include notching, by a notching device, the at least the portion of the electrode foil having the patterned surface to form a plurality of tabs on the electrode foil.

At least one aspect is directed to a battery. The battery can include one or more cells comprising one or more tabs formed from an electrode foil. The one or more tabs can include a surface having a pattern to increase a bending stiffness of the tab.

At least one aspect is directed to a method of providing a system. The system can include a first roller including a first surface comprising a pattern to form a patterned surface on an electrode foil. The system can include the first roller to deform the electrode foil to create the patterned surface on the electrode foil with at least a portion of the electrode foil disposed between the first surface of the first roller and a second surface. The second surface can be configured to support the electrode foil.

At least one aspect is directed to a method of providing a battery. The battery can include one or more cells comprising one or more tabs formed from an electrode foil. The one or more tabs can include a surface having a pattern to increase a bending stiffness of the tab.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system for manufacturing an electrode, in accordance with some aspects.

FIG. 2 depicts an example system for manufacturing an electrode, in accordance with some aspects.

FIG. 3 depicts an example system for manufacturing an electrode, in accordance with some aspects.

FIG. 4 depicts an example system for manufacturing an electrode, in accordance with some aspects.

FIG. 5 depicts an example system for manufacturing an electrode, in accordance with some aspects.

FIG. 6 depicts an example electrode, in accordance with some aspects.

FIG. 7 depicts an example profile of a protrusion of a system for manufacturing an electrode, in accordance with some aspects.

FIG. 8 depicts an example profile of a protrusion of a system for manufacturing an electrode, in accordance with some aspects.

FIG. 9 depicts an example profile of a protrusion of a system for manufacturing an electrode, in accordance with some aspects.

FIG. 10 depicts an example profile of a protrusion of a system for manufacturing an electrode, in accordance with some aspects.

FIG. 11 depicts an example profile of a protrusion of a system for manufacturing an electrode, in accordance with some aspects.

FIG. 12 depicts an example electrode, in accordance with some aspects.

FIG. 13 is a flow chart of an example method of manufacturing an electrode, in accordance with some aspects.

FIG. 14 depicts an example electric vehicle, in accordance with some aspects.

FIG. 15 depicts an example battery pack, in accordance with some aspects.

FIG. 16 depicts an example battery module, in accordance with some aspects.

FIG. 17 depicts a cross sectional view of an example battery cell, in accordance with some aspects.

FIG. 18 depicts a cross sectional view of an example battery cell, in accordance with some aspects.

FIG. 19 depicts a cross sectional view of an example battery cell, in accordance with some aspects.

FIG. 20 is a flow chart of an example method of providing a system for manufacturing an electrode, in accordance with some aspects.

FIG. 21 is a flow chart of an example method of providing a battery cell, in accordance with some aspects.

### DETAILED DESCRIPTION

Following below are more detailed descriptions of various concepts related to, and implementations of, methods, apparatuses, and systems of battery electrode and manufacture thereof. The various concepts introduced above and discussed in greater detail below may be implemented in any of numerous ways.

The present disclosure is directed to systems and methods of battery manufacturing. For example, the present disclosure is directed to systems and methods of battery electrode manufacturing. Battery electrodes can include an electrode foil (e.g., a copper foil, an aluminum foil, or some other foil including but not limited to carbon coated metal foil, edge insulated metal foil) to which a battery active material (e.g., a slurry, film, layer, sheet, or coating having battery active material, carbon conductive agent, and binder) can be applied. The battery active material can be applied to a first portion of the electrode foil, while a remainder of the electrode foil can be uncoated (e.g., not coated with battery active material from the slurry). The uncoated portion can ultimately serve as a tab of the electrode that can facilitate the creation of an electrical connection between the electrode and some other electrically conductive object (e.g., another electrode, a terminal of a battery cell, or some other object). The uncoated portion of the electrode foil can be or include a portion of the electrode foil extending from a web of electrode material (e.g., battery active material and electrode foil material). The uncoated portion can be flimsy, thin, or non-rigid with the electrode foil unsupported or subject to gravitational forces, as might occur during processing of the electrode web.

The present disclosure relates to a system for deforming the uncoated portion of the electrode foil to create a pattern or texture. For example, the system can include a roller having a patterned element with a patterned surface. The pattered surface of the patterned element can contact the uncoated portion of the electrode web and apply a force or pressure to the uncoated portion. The patterned surface of the patterned element can deform the uncoated portion to create at least one deformation of the uncoated portion. The deformation can be a linear deformation, a non-linear deformation, or some other deformation having one or more profiles (e.g., cross-sectional geometry). The deformation can correspond to at least one protrusion of the patterned element, where the protrusion of the patterned element can form the patterned surface of the patterned element. The system can include a second surface. The patterned element can apply a pressure to the uncoated portion to deform the uncoated portion with the uncoated portion positioned between the patterned element and the second surface. The second surface a can be a roller, a flat surface, or some other surface. The system can deform the uncoated portion of the electrode foil prior to a notching operation or some other operation. The system can deform the uncoated portion of the electrode foil after a notching operation or some other operation.

The systems and methods of the present disclosure can deform the uncoated portion to create at least one deformation. The deformation can increase a bending stiffness of the uncoated portion or can modify an area moment of inertia of the uncoated portion to improve a rigidity of the uncoated portion. The disclosed solutions have a technical advantage of increasing the stiffness or rigidity of the uncoated portion such that the uncoated portion is less susceptible to bending, creasing, folding, or other damage as the electrode web is processed to manufacture electrodes. For example, the uncoated portion can be subject to gravitational forces, among others, during manufacture of an electrode web or an electrode, where the forces can cause the uncoated portion to sag, bend, hang, droop, or otherwise flex, which can lead to the uncoated portion becoming inadvertently creased, folded, crimped, or damaged.

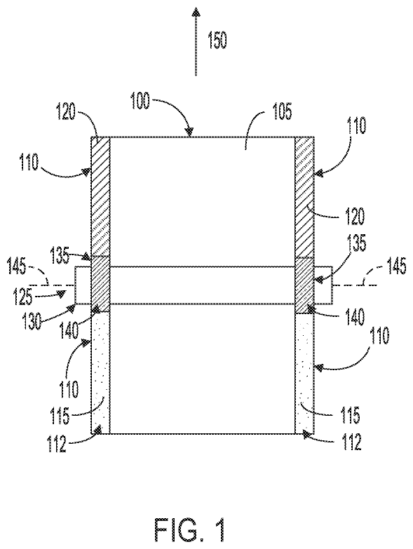

FIG. 1, among others, depicts an electrode web 100 and a system 125 for manufacturing the electrode web 100. For example, the electrode web 100 can be or include a web (e.g., sheet, film, layer) of electrode material that can be used to create an electrode for a battery. For example, the electrode web 100 can be a web of electrode material that can be altered (e.g., cut, singulated, modified, trimmed) to create an individual electrode, a continuous sheet of electrodes, or some other group of electrodes. The electrode web 100 can be altered to create an electrode for a battery or battery cell, such as a lithium-ion battery, a solid-state battery (e.g., a solid-state lithium-ion battery), a nickel-zinc battery cell, a zinc-bromine battery cell, a zinc-cerium battery cell, a sodium-sulfur battery cell, or a nickel-cadmium battery cell, or some other type of battery. The electrode web 100 can be of any shape and dimension. For example, the electrode web 100 can be rectangular, square, or polygonal, or some other shape.

The electrode web 100 can include at least one battery active material layer 105 and an electrode foil 110. The electrode web 100 can include at least one battery active material layer 105 joined with the electrically conductive foil layer 110. For example, the electrode web 100 can include a first battery active material layer 105 joined with (e.g., laminated to, coated on, adhered to) a first side of the electrode foil 110 and a second battery active material layer 105 joined with (e.g., laminated to, coated on, adhered to) a second side of the electrically conductive foil layer 110. The electrode web 100 can include the first battery active material layer 105 joined with at least a portion of the electrode foil 110 such that a portion of the electrode foil 110 is coated with the battery active material layer 105 and a second portion of the electrode foil 110 is not coated (i.e., uncoated, free from) the battery active material layer 105. The battery active material layer 105 can be or include an anode active material or a cathode active material. For example, the electrode web 100 can be an anode electrode with a first battery active material layer 105 having an anode chemistry coated on a top of the electrode foil 110 and a second battery active material layer 105 having an anode chemistry coated on a bottom of the electrode foil 110. The electrode web 100 can be a cathode electrode with a first battery active material layer 105 having a cathode chemistry coated on a top of the electrode foil 110 and a second battery active material layer 105 having a cathode chemistry coated on a bottom of the electrode foil 110.

The electrode foil 110 can include an uncoated portion 112. For example, the electrode foil 110 can include a coated portion (e.g., portion, zone, region) and an uncoated portion 112 (e.g., portion, zone, region). The coated portion can be an area of the electrode foil that is coated with the battery active material layer 105. For example, the coated portion can be a portion of the electrode foil 110 that is sandwiched between two battery active material layers 105 or a portion of the electrode foil 110 to which at least one battery active material layer 105 is applied. The uncoated portion 112 can be a portion of the electrode foil 110 that is not coated with a battery active material layer 105. For example, the uncoated portion 112 can be a portion of the electrode foil 110 that extends from at least one side of a battery active material layer 105 or a portion of the electrode foil 110 that is positioned between battery active material layers 105. The uncoated portion 112 can include a surface 115. For example, the surface 115 of the uncoated portion 112 can be area of the electrode foil 110 that is accessible or visible from a top or a bottom of the electrode web 100. For example, unlike a surface of the coated area of the electrode foil 110, the surface 115 of the uncoated portion 112 of the electrode foil 110 is accessible (e.g., exposed to air) from a top or bottom of the electrode web 100. The uncoated portion 112 of the electrode foil 110 can extend from a side of the electrode 110 to electrically couple an electrode produced from the electrode web 100 (e.g., the electrode foil 110 of the electrode web 100) and some other object, such as a current collector, at least one other electrode, or some other object. The uncoated portion 112 of the electrode foil 110 can be adjacent to the coated area of the electrode foil 110. The uncoated portion 112 can be positioned between coated portions. The coated portion can be positioned between multiple uncoated portions 112. For example, a first uncoated portion 112 can be positioned to a first side of the coated portion and a second uncoated portion 112 can be positioned on a second side of the coated portion.

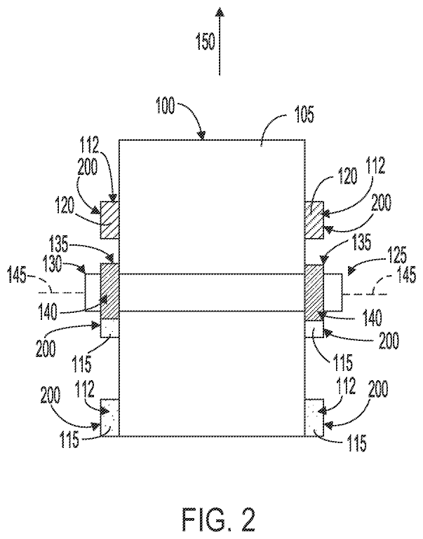

The uncoated portion 112 can be formed into an electrode tab 200. For example, as depicted in FIG. 2, among others, the electrode foil 110 can be notched (e.g., cut, trimmed, sliced, or otherwise modified) to remove a portion of the uncoated portion 112 and to leave the electrode tab 200 as a remaining portion. The electrode web 100 can include the electrode foil 110 including the uncoated portion 112 notched to create multiple electrode tabs 200. For example, multiple electrode tabs 200 can be positioned along a first side of the electrode web 100 and multiple electrode tabs 200 can be positioned along a second side of the electrode web 100. The coated area (e.g., the area of the electrode foil 110 to which the battery active material layer 105 is applied) ca be positioned or disposed between at least one electrode tab 200 positioned on a first side of the electrode web 100 and at least one electrode tab 200 positioned on a second side of the electrode web 100.

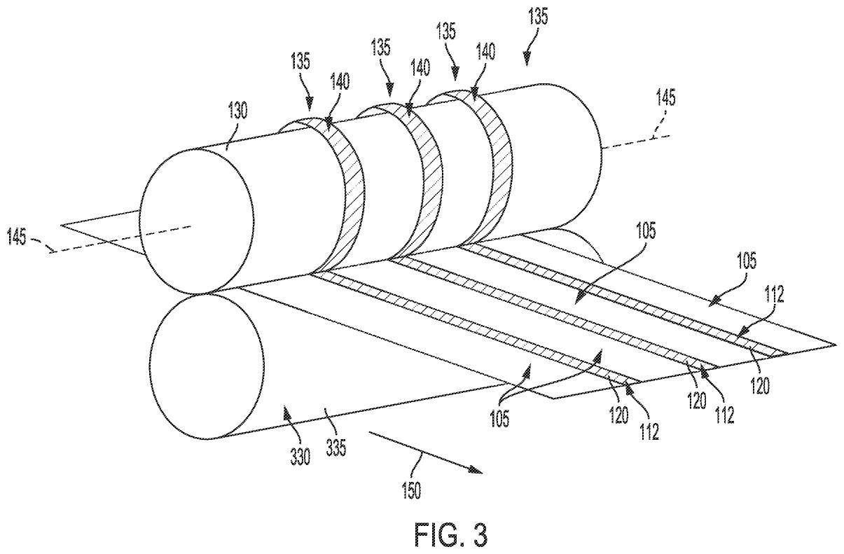

As depicted in FIG. 3, among others, the electrode web 100 can include multiple battery active material layers 105 coupled with the electrode foil 110. For example, multiple battery active material layers 105 can extend parallelly along the electrode foil 110. The uncoated portion 112 of the electrode foil 110 can be positioned between adjacent battery active material layers 105. For example, a portion of the electrode foil 110 between two adjacent battery active material layers 105 can be uncoated (e.g., not coated with any battery active material layer 105). The electrode foil 110 can be continuous between adjacent battery active material layers 105. For example, a first battery active material layer 105 and a second battery active material layer 105 can both be coupled with the same electrode foil 110 with the uncoated portion 112 of the electrode foil 110 existing therebetween. The electrode web 100 can include multiple uncoated portions 112 positioned between adjacent battery active material layers 105. For example, as depicted in FIG. 3, among others, the electrode web 100 can include four battery active material layers 105 and three uncoated portions 112 of the electrode foil 110. The electrode web 100 can include some other number of battery active material layers 105 or uncoated portions 112. The battery active material layer 105 can be positioned along an edge of the electrode web 100 or positioned away from the edge of the electrode web 100. For example, no uncoated portion 112 of the electrode foil 110 can exist between an outer edge of the battery active material layer 105 and the edge of the electrode web 100, or the uncoated portion 112 can exist between the outer edge of the battery active material layer 105 and the edge of the electrode web 100.

As depicted in FIGS. 1-5, among others, the system 125 can be used to manufacture the electrode web 100. For example, the system 125 can be a system, device, apparatus, or machine that is used independently or in concert with other systems, devices, apparatuses, or machines to produce the electrode web 100. The system 125 can be a system to create a pattern on the electrode foil 110. For example, the system 125 can be a system to create a patterned surface on the uncoated portion 112 of the electrode foil 110. The system 125 can include at least one roller 130. The roller 130 can be a first roller. The roller 130 can rotate about an axis 145. The roller 130 can include at least one patterned element 135. For example, the patterned element 135 can be a wheel, cylinder, or surface (e.g., region, portion, section) of the roller 130 having a patterned surface 140. The patterned element 135 can extend from the roller 130. For example, rather than being a pattern formed directly on the roller 130, the patterned element 135 can be a separate element or component that is coupled with the roller 130, such as a wheel or cylinder coupled with (e.g., attached around) the roller 130 with the patterned surface 140 facing outward. The patterned element 135 can also be a portion of the roller 130 having the patterned surface 140.

The system 125 can include the roller 130 to deform the electrode foil 110 to create a patterned surface 120. For example, the patterned element 135 of the system 125 can include the patterned surface 140 to contact the electrode foil 110 and to deform the electrode foil 110. The patterned element 135 can contact the uncoated portion 112 of the electrode foil 110. For example, the patterned element 135 can apply a pressure (e.g., a force) to the uncoated portion 112 of the electrode foil 110. The pressure applied by the patterned element 135 can deform (e.g., bend, stretch, deflect, warp, shape) the uncoated portion 112 with the patterned element 135 contacting the uncoated portion 112. For example, the patterned surface 140 of the patterned element 135 can impart a pattern, bends, ridges, valleys, texture, bumps, curvature, ripples, or some other deformation to the uncoated portion 112 to create the patterned surface 120. The uncoated portion 112 can be deformed by the patterned element 135 such that the uncoated portion 112 includes the patterned surface 120 after the patterned element 135 contacts the uncoated portion 112. The patterned surface 120 can include a pattern, bends, ridges, valleys, texture, bumps, curvature, ripples, or some other deformation. For example, the patterned surface 120 can have a pattern that corresponds to a pattern of the patterned surface 140 of the patterned element 135.

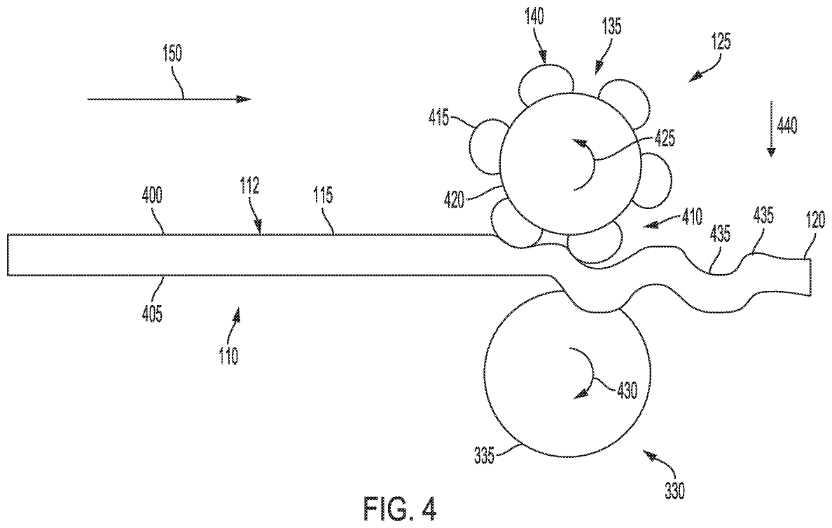

As depicted in FIG. 4, among others, the system 125 can include the patterned surface 140 of the patterned element 135 including at least one protrusion 415. For example, the patterned surface 140 of the patterned element 135 can include multiple protrusions 415 extending from the patterned element 135 to form the patterned surface 140. The protrusion 415 can be a bump, ridge, peak, crest, projection, or other member protruding from the patterned element 135. The protrusion 415 can be a linear protrusion, a curvilinear protrusion, a circular protrusion, a rectangular protrusion, or a protrusion forming some other shape. For example, the protrusion 415 can extend across the patterned element 135 (e.g., from one end of the patterned element 135 to another end of the patterned element 135). The protrusion 415 can be positioned on a portion or within an area of the patterned element 135. The protrusion 415 can extend radially around the patterned element 135 or over some radial length of the patterned element 135. The patterned element 135 can include multiple similar or dissimilar protrusions 415 extending therefrom, where the protrusions 415 form a pattern of the patterned surface 140.

For example, the patterned element 135 can include the patterned surface 140 having can include an embossed surface or some other surface formed by the protrusion 415. The patterned surface 140 can be linear or non-linear, and can include a random, symmetrical, ordered, or asymmetrical pattern based on the protrusions 415. For example, the non-linear pattern can include a pattern formed by one or more protrusions 415 that are not arranged along a straight line along the patterned element 135. The patterned element 135 can include at least one patterned surface 140 (e.g., a non-linear embossed pattern, or an embossed pattern). For example, the patterned element 135 can include two or more patterns. Substantially (e.g., 95%) the entire outer surface of the patterned element 135 can include the patterned surface 140. Some portion of the patterned element 135 (e.g., half of the outer surface of the patterned element 135, two-thirds of the outer surface of the patterned element 135) can include the patterned surface 140. The patterned element 135 can include multiple discrete portions (e.g., individual, disconnected, noncontinuous) having the patterned surface 140 with portions positioned at least partially therebetween without the patterned surface 140 (e.g., a smooth surface or some other un-patterned surface). The patterned surface 140 can include a non-linear pattern along an axis parallel to a boundary of the patterned element 135 (e.g., an axis parallel to the direction 150). The patterned surface 140 can include a random pattern or a periodic pattern. For example, the patterned surface 140 can include a non-linear periodic arrangement. The patterned surface 140 can include a pattern having three-dimensional features or two-dimensional features. The patterned surface 140 can be symmetric or asymmetric. The patterned surface 140 can include at least one raised (e.g., protruding) protrusion 415. The patterned surface 120 can include at least one depression between adjacent protrusions or formed in the outer surface of the patterned element 135.

The protrusion 415 of the patterned element 135, and thus the patterned surface 140 can have a height or depth in a range of 0.1 mm to 10 mm (e.g., 0.1 mm, 0.5 mm, 1 mm, 4 mm, 8 mm, 10 mm, or some other number). The protrusion 415 have a height or depth of less than 0.1 mm. The protrusion 415 can have a height or depth of greater than 10 mm. The patterned element 135 can include multiple protrusions 415, where two or more protrusions 415 can have the same depth or height, or a different depth or height. The protrusions 415 can have a width in a range of 0.1 mm to 20 mm (e.g., 0.1 mm, 0.5 mm, 1 mm, 4 mm, 8 mm, 10 mm, or some other number). The protrusion 415 can have a width of less than 0.1 mm. The protrusion 415 can have a width of greater than 20 mm. The width of the protrusion 415 can vary along the height of the protrusion 415. For example, the width can narrow as the protrusion 415 extends from the patterned element such that the protrusion 415 has a narrowing (e.g., pointed) profile or shape. The patterned surface 140 can be formed by multiple protrusion 415, where two or more protrusions 415 can have the same width or different widths. The protrusion 415 can be spaced 0.1 to 30 mm away from a neighboring protrusion 415. For example, two adjacent protrusions 415 can be 0.1 mm apart, 30 mm apart, or some other distance (e.g., greater than 0.1 mm, 0.5 mm, 1 mm, 4 mm, 8 mm, 10 mm, 30 mm, or some other number). The protrusion 415 can be spaced greater than 30 mm away from a neighboring protrusion 415. The protrusion 415 can extend along the patterned element 135 for a length of 0.1 to 20 mm. For example, the protrusion 415 can extend linearly, nonlinearly, or in some other fashion for a length of less than 0.1 mm, 20 mm, or some length therebetween (e.g., 0.5 mm, 1 mm, 4 mm, 8 mm, 10 mm, 30 mm, or some other number). The protrusion 415 can extend along the patterned element 135 for some other length (e.g., less than 0.1 mm, greater than 20 mm). The patterned element 135 can include multiple protrusions 415 have the same height or different heights. The patterned element 135 can include multiple protrusions 415 spaced apart from a neighboring protrusion 415 by the same or different distances. The patterned element 135 can include multiple protrusions 415 have the same length or different lengths. The protrusion 415 can be continuous or non-continuous (e.g., including multiple discrete segments).

The system 125 can include the protrusion 415 of the patterned element 135 to deform the electrode foil 110 to create at least one deformation 435. For example, the protrusion 415 of the patterned element 135 can contact the uncoated portion 112 of the electrode foil 110. The protrusion 415 of the patterned element 135 that forms the patterned surface 140 can apply a pressure (e.g., a force) to the uncoated portion 112 of the electrode foil 110. The pressure applied by the protrusion 415 of the patterned element 135 can deform (e.g., bend, stretch, deflect, warp, shape) the uncoated portion 112 with the patterned element 135 contacting the uncoated portion 112. For example, the protrusion 415 forming the patterned surface 140 of the patterned element 135 can impart a pattern, bends, ridges, valleys, texture, bumps, curvature, ripples or some other deformation to the uncoated portion 112 to create the patterned surface 120. The uncoated portion 112 can be deformed by the protrusion 415 of the patterned element 135 such that the uncoated portion 112 includes the patterned surface 120 after the protrusion 415 patterned element 135 contacts the uncoated portion 112. The patterned surface 120 can include a pattern, bends, ridges, valleys, texture, bumps, curvature, ripples, or some other deformation. For example, the patterned surface 120 can have a pattern that corresponds to the patterned surface 140 formed by the protrusion 415 of the patterned element 135.

The system 125 can include the roller 130 to deform the electrode foil 110 to create the patterned surface 120 as the electrode web 100 moves relative to the roller 130. For example, the system 125 can include the roller 130 to rotate about the axis 145 as the electrode web 100 moves in the direction 150. The electrode web 100 can move (e.g., be pulled or fed) in the direction 150 such that the uncoated portion 112 of the electrode foil 110 contacts the patterned surface 140 of the patterned element 135. For example, the patterned surface 140 can contact the uncoated portion 112 as the electrode web 100 moves in the direction 150. The patterned element 135 can deform the uncoated portion 112 of the electrode foil 110 as the electrode web 100 moves in the direction 150. For example, the electrode web 100 can be continually (e.g., at some rate for a period of time) or incrementally (e.g., for some interval of time) move in the direction 150 with the uncoated portion 112 contacting the patterned element 135. The electrode web 100 can move in the direction 150 at a constant rate or at a variable rate. The electrode web 100 can move in the direction 150 for some interval of time such that a desired length of the uncoated portion 112 of the electrode foil 110 contacts the patterned element 135. The uncoated portion 112 of the electrode foil 110 upstream from the system 125 (e.g., a portion that has not yet contacted the patterned element 135) can be include the surface 115 without any pattern. The uncoated portion 112 of the electrode foil 110 downstream from the system 125 (e.g., a portion that has already contacted the patterned element 135 can be include the patterned surface 120.

The system 125 can include a linearly-actuating device to form the patterned surface 120 on the uncoated portion 112 of the electrode web 100. For example, rather than include the roller 130, the system 125 can include the patterned element 135 having the patterned surface 140 to move in a direction perpendicular to the direction 150 and to compress (e.g., stamp, squeeze, clamp, or otherwise apply a pressure to) the uncoated portion 112 of the electrode foil 110. The patterned element 135 can be linearly actuated by a pneumatic cylinder, hydraulic cylinder, electrically-powered linear actuator, or some other device. For example, the patterned surface 140 of the patterned element 135 can contact the uncoated portion 112 of the electrode foil 110 and to apply a pressure to the uncoated portion 112. The pressure applied by the patterned element 135 can deform the uncoated portion 112 of the electrode foil 110 to create the patterned surface 120 on the electrode foil 110. For example, the pattern of the patterned surface 140 of the patterned element 135 can be formed on the uncoated portion 112 with the with the patterned element 135 contacting the uncoated portion 112. The patterned element 135 can be otherwise actuated (e.g., pivot, slide, rotate about an axis perpendicular to the axis 145) to contact the uncoated portion 112, deform the uncoated portion 112, or create the patterned surface 120 of the uncoated portion 112.

As depicted in FIG. 1, among others, the system 125 can include the first roller 130 to deform the electrode foil 110 to create the patterned surface 120 with the uncoated portion 112 being continuous. For example, the uncoated portion 112 of the electrode foil 110 can be continuous in the direction 150. The uncoated portion 112 can extend along an entire length of the electrode web 100 as a single, continuous portion. The patterned surface 140 of the patterned element 135 can deform the continuous uncoated portion 112 to create a continuous portion of the electrode foil 110 having the patterned surface 120. As depicted in FIG. 2, among others, the system 125 can include the first roller 130 to deform the electrode foil 110 with the uncoated portion 112 being discontinuous. For example, the electrode web 100 can be notched (e.g., by a notching device) to remove at least a part of the uncoated portion 112 such that only electrode tabs 200 (e.g., discrete segments of the uncoated portion 112 of the electrode foil 110) remain. Instead of extending along the electrode web 100 as a continuous strip or section, the uncoated portion 112 can extend from electrode web 100 as individual electrode tabs 200 or segments. For example, the electrode web 100 can include the battery active material layer 105 extending along a center of the electrode web 100 and electrode tabs 200 (e.g., segments of the uncoated portion 112) of the electrode foil 110 extending from the battery active material layer 105 to one or more sides of the battery active material layer 105, as depicted in FIG. 2, among others.

The system 125 can include the first roller 130 to deform the electrode foil 110 to create the patterned surface 120 on the electrode foil 110 with at least a portion of the electrode foil 110 disposed between a first surface of the first roller and a second surface. For example, the first surface of the first roller 130 can be the patterned surface 140 of the patterned element 135. The uncoated portion 112 of the electrode foil 110 can be positioned between the patterned surface 140 of the patterned element 135 and a second surface. For example, the patterned surface 140 and the second surface can contact the uncoated portion 112 of the electrode foil 110 with the electrode foil 110 at least partially disposed between the patterned surface 140 and the second surface. The patterned surface 140 of the patterned element 135 can contact the uncoated portion 112 to deform the uncoated portion 112 with the uncoated portion 112 supported by the second surface and compressed between the patterned surface 140 and the second surface. For example, the uncoated portion 112 can be squeezed or compressed between the second surface and the patterned surface 140 to deform the uncoated portion 112 and to create the patterned surface 120.

As depicted in FIGS. 3-5, among others, the second surface can be a second surface 335 of a second roller 330. The second roller 330 can be positioned adjacent to (e.g., within one centimeter of, within 5 mm of) the roller 130. For example, the second roller 330 can rotate about an axis that is parallel with the axis 145 about which the first roller 130 rotates with the second roller 330 positioned adjacent to the first roller 130. The first roller 130 and the second roller 330 can form at least one nip 410 (e.g., pressure point, gap) between the first roller 130 and the second roller 330. The nip 410 can receive the electrode web 100 such that the electrode web 100 can be at least partially positioned between the first roller 130 and the second roller 330. The nip 410 can at least partially receive the electrode web 100 such that the first roller 130 and the second roller 330 can cooperate to create the patterned surface 120 on the uncoated portion 112 of the electrode web 100. For example, the patterned surface 140 of the patterned element 135 can contact the uncoated portion 112 with the electrode web 100 positioned within the nip 410. A distance between the patterned surface 140 of the patterned element 135 and the second surface 335 of the second roller 330 can be sufficiently small such that a pressure is applied to the electrode web 100 (e.g., to the uncoated portion 112 of the electrode web 100) with the electrode web 100 within the nip 410.

As depicted in FIG. 4, among others, the uncoated portion 112 of the electrode foil 110 can include a first side 400 and a second side 405. The system 125 can include the first roller 130 to contact the first side 400 of the electrode foil 110 and the second surface (e.g., the second surface 335 of the second roller 330) to contact the second side 405 of the uncoated portion 112 of the electrode foil 110. For example, the patterned surface 140 of the patterned element 135 can contact the first side 400 of the uncoated portion 112 with the uncoated portion 112 at least partially disposed between the patterned surface 140 of the first roller 130 and the second surface (e.g., the surface 335 of the second roller 330). The second surface (e.g., the surface 335 of the second roller 330) can contact the second side 405 of the uncoated portion 112 with the uncoated portion 112 at least partially disposed between the patterned surface 140 of the first roller 130 and the second surface. The patterned surface 140 of the patterned element 135 of the first roller 130 can contact the first side 400 of the uncoated portion 112 with the electrode web 100 at least partially positioned within the nip 410 between the first roller 130 and the second surface. For example, the patterned element 135 can apply a pressure to the uncoated portion 112 to deform the uncoated portion 112 and impart the pattern of the patterned surface 140 onto the uncoated portion 112 to create the patterned surface 120. The second surface (e.g., the second surface 335 of the second roller 330) can contact the second side 405 of the uncoated portion 112 with the electrode web 100 at least partially positioned within the nip 410 between the first roller 130 and the second surface. The second surface can apply a pressure to the uncoated portion 112 to facilitate the deformation of the uncoated portion 112. For example, the second surface can apply a pressure to the uncoated portion 112 to facilitate the deformation of the uncoated portion 112 by the patterned element 135 of the first roller 130. The second surface can act as a rigid or semi-rigid member against which the patterned element 135 of the first roller 130 can apply a pressure to deform the uncoated portion 112. The second surface can apply a pressure to the uncoated portion 112 such that the second surface itself can deform the uncoated portion 112 to create the patterned surface 120.

For example, the system 125 can include the second surface having a patterned element or a patterned surface. For example, the surface 335 of the second roller 330 can be or include a patterned surface, a textured surface, an irregular surface, or some other surface. The second surface 335 can include a texture, one or more protrusions or depressions, a pattern or arrangement of protrusions, depressions or valleys, or some other surface finish. The second surface 335 can include a pattern that differs from the patterned surface 140 of the patterned element 135. The surface 335 can include a pattern that corresponds to or is similar to the patterned surface 140 of the patterned element 135. For example, the patterned surface 140 can include at least one protrusion. 415 that corresponds with a depression or valley of the surface 335 such that the protrusion 415 of the patterned surface 140 is at least partially received in the depression or valley of the surface 335. The patterned surface 140 can include at least one depression 420 or valley that corresponds to a protrusion of the surface 335 such that the protrusion of the surface 335 can be at least partially received by the depression 420 or valley of the patterned surface 140. For example, the patterned surface 140 of the patterned element 135 can mesh or integrate with the surface 335 of the second roller 330 as the first roller 130 rotates in the direction 425 and the second roller 330 rotates in the direction 430.

The system 125 can include the second surface to deform the uncoated portion 112 of the electrode web 100. For example, the second surface can include the patterned surface, textured surface, or some other surface finish. The second surface can apply a pressure to the uncoated portion 112 of the electrode foil 110 with the electrode web 100 at least partially positioned within the nip 410. For example, as depicted in FIGS. 3-5, among others, the electrode web 100 can be received between first roller 130 and the second surface with the second surface being the second surface 335 of the second roller 330. The first roller 130 and the second roller 330 can apply a force or pressure to the uncoated portion 112 of the electrode foil 110. For example, the second roller 330 can apply a compressive force to the uncoated portion 112 of the electrode foil 110 via the second surface 335. The compressive force imparted on the uncoated portion 112 by the second roller 330 can cause the patterned finished, textured finished, or other surface finish of the second surface 335 to deform the uncoated portion 112 of the electrode foil 110. The second surface 335 can create a deformation (e.g., the deformation 435) on the uncoated portion 112 of the electrode foil 110 by applying the pressure or compressive force to the uncoated portion 112.

The system 125 can include the patterned surface 140 of the first roller 130 and the second surface 335 of the second roller 330 to deform the uncoated portion 112 of the electrode foil 110. For example, the patterned surface 140 of the first roller 130 and the second surface 335 of the second roller 330 can each include a pattern, texture, or other surface finish to contact the uncoated portion 112 of the electrode foil 110 with the uncoated portion 112 of the electrode foil positioned at least partially within the nip 410 and between the first roller 130 and the second roller 330. For example, the patterned surface 140 of the first roller 130 can contact the first side 400 of the uncoated portion 112 and the second surface 335 of the second roller 330 can contact the second side 405 of the uncoated portion 112. Both the patterned element 135 and the second roller 330 can impart a force on or against the uncoated portion 112 of the electrode foil 110 with the electrode web 100 at least partially received within the nip 410. The patterned surface 140 of the patterned element 135 can deform the uncoated portion 112 to create at least one deformation 435. The second surface 335 of the second roller 330 can deform the uncoated portion 112 to create at least one deformation 435.

The second surface can be a smooth surface. For example, the second surface 335 of the second roller 330 can be an untextured, smooth, uniform, non-rough surface that substantially (e.g., +95%) does not include any pattern, texture, or irregularity. The second roller 330 can apply a force or pressure to the uncoated portion 112 of the electrode foil 110 with the electrode web 100 at least partially received within the nip 410. The second roller 330 can include a smooth second surface 335 such that the second surface 335 does not itself deform the uncoated portion 112 of the electrode foil 110 with the second roller 330 applying the force or pressure to the uncoated portion 112.

The second surface can be some other surface (e.g., a surface other than the surface 335 of the second roller 330). For example, the second surface can be a flat surface, a curved surface, a textured surface, or some other surface. The second surface can be a surface of a flat conveyor surface, such as a rubberized conveyor belt. The second surface can be a flat surface, such as a table or platform. The second surface can be flat, curved, patterned, textured, contoured, or otherwise shaped. The second surface can be a static surface. For example, the second surface can be static as the system 125 moves (e.g., as the first roller 130 rotates) to deform the uncoated portion 112 to create the patterned surface 120. The second surface can be a dynamic surface. For example, the second surface can move relative as the system 125 is static or moves (e.g., as the first roller 130 rotates) to deform the uncoated portion 112 to create the patterned surface 120.

The system 125 can include second surface 335 including a malleable material. For example, the second roller 330 can include the second surface 335 including a malleable material such as rubber, foam, a rubberized polymeric material, or some other material. The malleable material of the second roller 330 can be positioned around the second roller 330 such that the second surface 335 of the second roller 330 can be the malleable material. For example, the roller 330 can include a rigid portion (e.g., a metallic or rigid polymeric) center with a malleable material positioned on the around the rigid center. The malleable material can slightly or temporarily deform with the protrusion 415 of the patterned element 135 of the roller 130 contacting the second roller 330. For example, as depicted in FIGS. 3-5, among others, the roller 130 (e.g., the first roller) and the second roller 330 can be positioned adjacent to each other and the electrode web 100 can be positioned at least partially between the roller 130 and the second roller 330. The first roller 130 can be positioned adjacent to the second roller 330 such that the protrusions 415 of the patterned element 135 of the roller 130 contact the second surface 335 of the second roller 330 with the roller 130 rotating in the direction 425 and the second roller 330 rotating in the direction 430. For example, the protrusion 415 can contact the second surface 335 such that the uncoated portion 112 of the electrode foil 110 positioned at least partially between the roller 130 and the second roller 330 can be deformed. The protrusion 415 can contact the second surface 335 of the second roller 330 through the electrode foil 110 (e.g., indirectly contact the second surface 335). A force applied by the protrusion 415 against the second surface 335 can cause the second surface 335 to partially or temporarily deform. For example, the protrusion 415 can apply a force against the electrode foil 110 and the second surface 335 with the electrode foil 110 positioned between the second surface 335 and the patterned element 135 of the first roller 130, where the applied force can deform the electrode foil 110 to create the patterned surface 120 and temporarily deform the second surface 335. The second surface 335 can temporarily deform such that once the force applied by the protrusion 415 ceases (e.g., once the protrusion 415 is no longer contacting the foil 110 or the second surface 335), the second surface 335 can spring back to its original shape or profile.

As depicted in FIG. 4, among others, the uncoated portion 112 of the can be deformed by the patterned element 135 to create the patterned surface 120, the patterned surface 120 including at least one deformation 435. For example, the patterned surface 120 can include an embossed deformation 435, a debossed deformation 435, or combinations thereof. The patterned surface 120 can be linear or non-linear, and can include a random, symmetrical, ordered, or asymmetrical pattern. For example, the non-linear pattern can include a pattern that is not arranged along a straight line. The patterned surface 120 can include a linear or non-linear debossed pattern. The uncoated portion 112 of the electrode foil 110 can include at least one patterned surface 120 (e.g., a non-linear embossed pattern, or an embossed pattern). For example, uncoated portion 112 of the electrode foil 110 can include two or more patterns. Substantially (e.g., 95%) the entire uncoated portion 112 of the electrode foil 110 can include the patterned surface 120. Some portion of the uncoated portion 112 (e.g., half of the uncoated portion 112, two-thirds of the uncoated portion 112) can include the patterned surface 120. The uncoated portion 112 can include multiple discrete portions (e.g., individual, disconnected, noncontinuous) having the patterned surface 120 with portions positioned at least partially therebetween without the patterned surface 120 (e.g., a smooth surface or some other un-patterned surface). The patterned surface 120 can be non-linear along an axis parallel to a boundary of the uncoated portion 112. The patterned surface 120 can include a random pattern or a periodic pattern. For example, the patterned surface 120 can include a non-linear periodic arrangement. The patterned surface 120 can include a pattern having three-dimensional features or two-dimensional features. The patterned surface 120 can be symmetric or asymmetric. The patterned surface 120 can include at least one raised (e.g., protruding) deformation 435. The patterned surface 120 can include at least one depressed deformation 435. The patterned surface 120 can include a combination of protruding deformations 435 and depressed deformations 435. For example, the patterned surface 120 can include a combination of protruding deformations 435 and depressed deformations 435 relative to a particular surface (e.g., the surface 400 or the surface 405). The patterned surface 120 can include only protruding deformations 435. The patterned surface 120 can include only depressed deformations 435. The protruding deformations 435 can be convex. For example, the protruding deformations 435 can be or include hills, mounds, bumps, impressions, or levels. The depressed deformations 435 can be concave. For example, the depressed deformations 435 can include valleys, insets, impressions, or levels. The depressed deformation 435 can be or include at least one score, mark, divot, dent, or scratch.

The size (e.g., height, depth, width, length, distance from an adjacent deformation) of the deformation 435 of the patterned surface 120 can vary according to a density some other characteristic of the electrode foil 110. The size (e.g., height, width, length, distance from an adjacent deformation) of the deformation 435 of the patterned surface 120 can vary according to the size (e.g., height, width, length, distance from an adjacent protrusion 415) of the protrusions 415 of the patterned element 135. For example, the deformation 435 can have a height or depth ranging from 0.1 mm to 10 mm (e.g., 0.1 mm, 0.5 mm, 1 mm, 4 mm, 8 mm, 10 mm, or some other number). The deformation 435 can have a height or depth greater than 10 mm (e.g., less than 20 mm, 20 mm, greater than 20 mm, or some other length). The deformation 435 can have a width in a range of 0.1 mm to 20 mm (e.g., 0.1 mm, 0.5 mm, 1 mm, 4 mm, 8 mm, 10 mm, or some other number). The deformation 435 can have a width of less than 0.1 mm. The deformation 435 can have a width of greater than 20 mm. The width of the deformation can vary along the depth of the deformation 435. For example, the width can narrow as the deformation 435 along the depth of such that the deformation 435 has a narrowing (e.g., pointed) profile or shape. The deformation 435 can be spaced 0.1 to 30 mm away from a neighboring deformation 435. For example, two adjacent deformations 435 can be 0.1 mm apart, 30 mm apart, or some other distance (e.g., greater than 0.1 mm, 0.5 mm, 1 mm, 4 mm, 8 mm, 10 mm, 30 mm, or some other number). The deformation 435 can be spaced greater than 30 mm away from a neighboring deformation 435. The deformation 435 can extend along the patterned element 135 for a length of 0.1 to 20 mm. For example, the deformation 435 can extend linearly, nonlinearly, or in some other fashion for a length of less than 0.1 mm, 20 mm, or some length therebetween (e.g., 0.5 mm, 1 mm, 4 mm, 8 mm, 10 mm, 30 mm, or some other number). The deformation 435 can extend along the patterned element 135 for some other length (e.g., less than 0.1 mm, greater than 20 mm). The uncoated portion 112 of the electrode foil 110 can include multiple deformations 435 have the same height or different heights. The uncoated portion 112 of the electrode foil 110 can include multiple deformations 435 spaced apart from a neighboring deformation 435 by the same or different distances. The uncoated portion 112 of the electrode foil 110 can include multiple deformations 435 have the same length or different lengths. The deformation 435 can be continuous or non-continuous (e.g., including multiple discrete segments).

The patterned surface 120 can increase a bending stiffness of the uncoated portion 112 of the electrode foil 110 (e.g., an electrode tab 200 or a continuous uncoated portion 112). For example, the patterned surface 120 can include one or more deformations 435 to increase a bending stiffness of the uncoated portion 112 of the electrode foil. The deformation 435 can be a linear deformation 435 extending perpendicular to an edge of the uncoated portion 112, an edge of the battery active material layer 105, or the direction 150. The deformation 435 can substantially (e.g., +95%) prevent the uncoated portion 112 from bending along a line parallel to the edge of the uncoated portion 112, the edge of the battery active material layer 105, or the direction 150 with the deformation 435 extending perpendicular or substantially perpendicular (e.g., +30°) thereto. For example, the deformation 435 can affect the area moment of inertia of the uncoated portion 112 of the electrode foil 110 such that the uncoated portion 112 is much more rigid or resistant to bending under force of gravity or other forces (e.g., forces experienced as the electrode web 100 moves in the direction 150). The deformation 435 can increase a tension within the uncoated portion 112 of the electrode foil 110 such that the uncoated portion 112 can be less susceptible to bending, flexing, sagging, or otherwise moving under gravitational forces or other forces experienced during manufacture of the electrode web 100.

For example, the electrode tab 200 or the continuous uncoated portion 112 of the electrode foil 110 can have a relatively small bending stiffness and relatively little tension without the patterned surface 120 such that the electrode tab 200 or the continuous uncoated portion 112 can bend (e.g., sag, hang, fold, crease, dip) relative to the remainder of the electrode web 100 (e.g., the electrode foil 110 coated with the battery active material layer 105) under gravitational forces (e.g., forces acting in a direction 440) or other forces experienced during electrode manufacture. The electrode tab 200 or the continuous uncoated portion 112 of the electrode foil 110 can have a relatively high bending stiffness and higher tension with the patterned surface 120 such that the electrode tab 200 or the continuous uncoated portion 112 substantially does not bend (e.g., sag, hang, fold, crease, dip) relative to the remainder of the electrode web 100 (e.g., the electrode foil 110 coated with the battery active material layer 105) under gravitational forces or other forces experienced during electrode manufacture. By increasing the stiffness of the uncoated portion 112 of the electrode foil 110, the patterned surface 120 can prevent the uncoated portion 112 from bending, sagging, folding, creasing, crimping, or being otherwise damaged during processing of the electrode web 100. For example, by increasing the bending stiffness of the uncoated portion 112 of the electrode foil 110, the patterned surface 120 can reduce manufacturing scrap or facilitate expedited processing times in the area of electrode manufacturing.

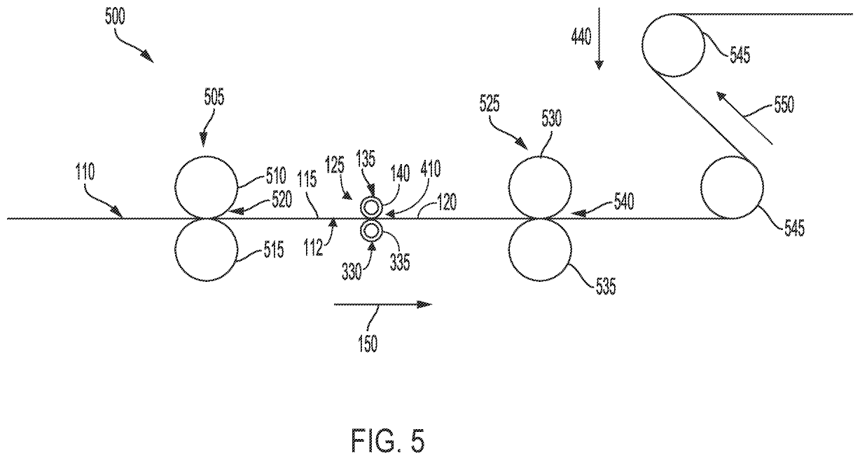

FIG. 5, among others, depicts a system 500 for manufacturing an electrode or an electrode web 100. For example, the system 500 can include the system 125, a notching device, and at least one web handling device 545. The notching device can cut, slice, tear, or otherwise break the uncoated portion 112 of the electrode foil 110 to form electrode tabs 200. For example, the uncoated portion 112 of the electrode foil 110 can be continuous (e.g., one uniform and integrally connected portion 112) before being notched by the notching device. The uncoated portion 112 of the electrode foil 110 can be discontinuous after the uncoated portion 112 is notched by the notching device. For example, the uncoated portion 112 can include multiple discrete electrode tabs 200 with the uncoated portion 112 of the electrode foil 110 notched by the notching device. The electrode web 100 can be notched by the notching device to remove at least a part of the uncoated portion 112 such that only electrode tabs 200 remain. The electrode tabs 200 can be discrete segments of the uncoated portion 112 of the electrode foil 110. For example, instead of extending along the electrode web 100 as a continuous strip or section, the uncoated portion 112 can extend from electrode web 100 as individual electrode tabs 200 or segments. The electrode web 100 can include the battery active material layer 105 extending along a center of the electrode web 100 and electrode tabs 200 (e.g., segments of the uncoated portion 112) of the electrode foil 110 extending from the battery active material layer 105 to one or more sides of the battery active material layer 105, as depicted in FIG. 2, among others.

As depicted in FIG. 5, among others, the notching device can be the notching device 525 positioned downstream from (e.g., after) the system 125 during an electrode or electrode web manufacturing. The notching device 525 can include a first roller 530 and a second roller 535. The first roller 530 and the second roller 535 can be positioned adjacent to each other to form a nip 540 (e.g., pressure point, gap). The nip 540 can receive the electrode web 100. For example, the electrode web 100 can move in the first direction 150 between the first roller 530 and the second roller 535 such that the electrode web 100 moves in the first direction 150 at least partially through the nip 540. The first roller 530 or the second roller 535 can include a blade, knife, or other sharp object that can contact the uncoated portion 112 of the electrode foil 110 to cut the uncoated portion 112. The blade can cut through the uncoated portion 112 to create the electrode tab 200. The notching device 525 can cut away a remaining (e.g., unwanted, scrap) portion of the uncoated portion 112 to leave multiple electrode tabs 200. For example, the notching device 525 can remove a scrap portion of the uncoated portion 112 or cause a scrap portion of the uncoated portion 112 to be removed from the electrode foil 110 such that the electrode tab 200 remains, but other portions of the uncoated portion 112 are removed. The blade of the notching device 525 can be coupled with the first roller 530 and can contact (e.g., press against) the second roller 535 to cut the uncoated portion 112 of the electrode foil 110. The notching device 525 can include at least one laser device to notch the electrode foil 110. For example, the notching device 525 can be or include a laser cutter configured to emit a beam at the uncoated portion 112. The beam can melt or otherwise cut through the uncoated portion 112 to notch the electrode tab 200 from the uncoated portion 112.

The system 500 can include a calendaring device 505. The calendaring device 505 can be positioned upstream from (e.g., prior to) the system 125. The calendaring device 505 can include a first roller 510 and a second roller 515. The first roller 510 and the second roller 515 can rotate about parallel axes. The first roller 510 and the second roller 515 can be positioned adjacent to each other to form a nip 520 (e.g., pressure point, gap). The nip 520 can receive the electrode web 100. For example, the electrode web 100 can move in the first direction 150 between the first roller 510 and the second roller 515 such that the electrode web 100 moves in the first direction 150 at least partially through the nip 520. The first roller 510 and the second roller 515 can contact the electrode web 100 with the electrode web 100 positioned at least partially within the nip 520. For example, the electrode web 100 can be compressed (e.g., squeezed, compacted, calendared) between the first roller 510 and the second roller 515. The battery active material layer 105 of the electrode web 100 can be compressed between the first roller 510 and the second roller 515. For example, the first roller 510 and the second roller 515 can apply a compressive pressure to the battery active material layer 105 applied to the electrode foil 110 in order to compact or increase a density of the battery active material layer 105 or for some other reason.

The system 500 can include the notching device 525 positioned upstream from (e.g., before) the system 125 such that the uncoated portion 112 of the electrode foil 110 can be notched to form electrode tabs 200 before the system 125 deforms the electrode foil 110 to create the patterned surface 120. For example, the system 125 can include the patterned element 135 of the roller 130 to deform the uncoated portion 112 of the electrode foil 110 to create the patterned surface 120 with the uncoated portion 112 including multiple discrete electrode tabs 200, as depicted in FIG. 2, among others. The system 500 can include some other device to further modify, process, or manipulate the electrode web 100. For example, the system 500 can include a slitting device to bisect or slice the electrode web 100 to create multiple electrode webs 100. The slitting device can include a blade or laser element to cut the electrode web 100 in half, for example. The system 500 can include a singulating device to singulate individual electrodes from the electrode web 100. The system 500 can include some other device, apparatus, or system to otherwise modify the electrode web 100.

The system 500 can include the web handling device 545 to facilitate a movement of the electrode web 100. For example, the web handling device 545 can be a roller that can cause the electrode web 100 to move in some direction as the web handling device 545 rotates. The web handling device 545 can be a conveyor device or some other device that can contact the electrode web 100 and cause the electrode web 100 to move. For example, the web handling device 545 can facilitate a movement of the electrode web 100 from a first operation (e.g., a notching operation) to some subsequent operation (e.g., a singulating operation, a slitting operation, or some other operation), where the first operation is separated from the second operation by some vertical or horizontal distance (e.g., less than one foot, one to ten feet, greater than ten feet, or some other distance). The web handling device 545 can cause a direction of movement of the electrode web 100 to change. For example, the electrode web 100 can move in the direction 150 with the electrode web 100 being processed by the system 125 to create the patterned surface 120. The electrode web 100 can subsequently move in the direction 550, which can be perpendicular to the direction 150 or at some other angle with respect to the direction 150. For example, multiple web handling devices 545 can be used as shown in FIG. 5, among others, to cause the electrode web 100 to move in the direction 550 based on a relative position of sequential web handling devices 545 (e.g., the relative horizontal or vertical positioning of one web handling device 545 relative to a neighboring web handling device 545).

The patterned surface 120 of the uncoated portion 112 of the electrode foil 110 can prevent the uncoated portion 112 from becoming bent, creased, folded, crimped, or otherwise damaged with the electrode web 100 moving in the direction 150, the direction 550, or some other direction. For example, because the uncoated portion 112 of the electrode foil 110 can include an increased bending stiffness, the uncoated portion 112 of the electrode foil 110 can avoid or substantially avoid (e.g., avoid 95% of) bending, sagging, folding, creasing, or being otherwise damaged as the electrode web 100 moves in the direction 150, the direction 550, some other direction, or changes from one direction to another. The increased bending stiffness of the uncoated portion 112 can reduce defects created in movement or conveyance of the electrode web 100 during electrode manufacturing operations.

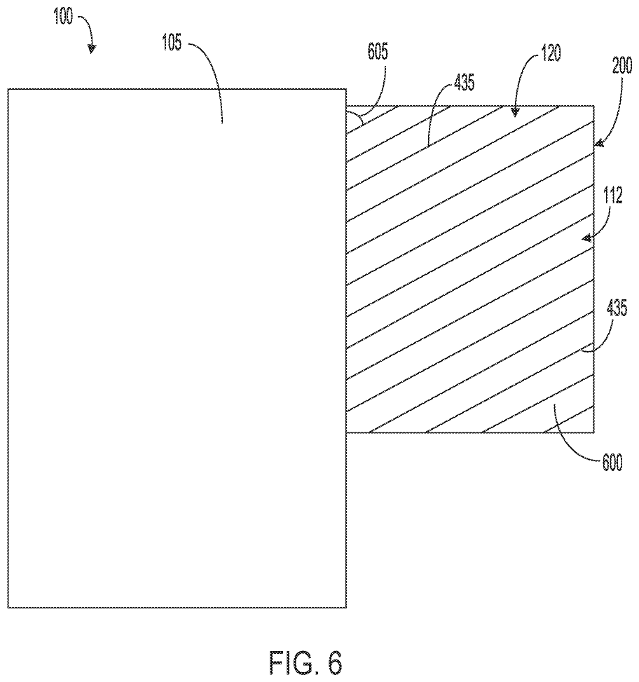

As depicted in FIG. 6, among others, the patterned surface 120 of the electrode foil 110 can include a pattern 600 with at least one deformation 435 oriented at an angle 605. For example, the patterned surface 120 can include multiple deformations 435 oriented at the angle 605 relative to an edge of the electrode foil 110, an edge of the battery active material layer 105, or some other edge. The angle 605 of the deformation 435 can correspond to an angle of the protrusion 415 of the patterned element 135. For example, the patterned element 135 can include multiple protrusions 415 (e.g., ridges, extensions, projections) extending from the patterned element 135 and multiple depressions 420 (e.g., troughs, valleys, grooves) corresponding to the multiple protrusions 415. The multiple protrusions 415 and the multiple depressions 420 can extend along the patterned element 135 in some direction, such as a direction parallel to the axis 145 about which the roller 130 and the patterned element 135 rotates, a direction perpendicular to the direction 150 in which the electrode web 100 moves relative to the system 125, or at some angle with respect to the axis 145 or the direction 150. The protrusions 415 and corresponding depressions 420 can be linear, in which case substantially (e.g., +95%) all of the protrusion 415 and corresponding depression 420 can extend in the same direction. The patterned surface 140 of the patterned element 135 can be or include a pattern having multiple protrusions 415 and corresponding depressions 420 extending along the patterned element 135 in some direction. The direction in which the multiple protrusions 415 and depressions 420 extend can cause the patterned surface 140 of the patterned element 135 to deform the uncoated portion 112 of the electrode foil 110 to create the patterned surface 120 of the electrode foil 110, where the patterned surface 120 can include the pattern 600 with at least one protrusion 415 or deformation 435 oriented at the angle 605. For example, the direction in which the multiple protrusions 415 or depressions 420 are positioned on the patterned element 135 can cause the pattern 600 to include the deformations 435 oriented at the angle 605.

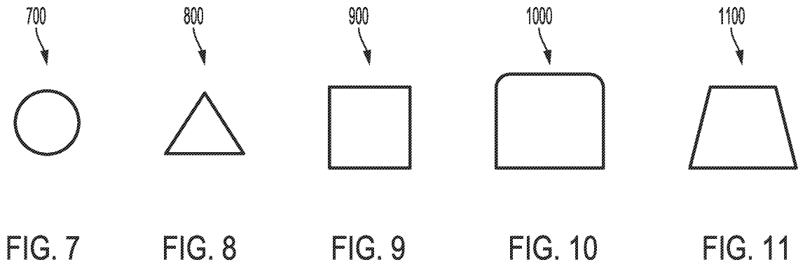

As depicted in FIGS. 7-11, the system 125 can include the patterned surface 140 of the patterned element 135 having at least one protrusion 415, the protrusion 415 including a profile. The profile of the protrusion 415 can be a shape, curvature, geometry, cross-sectional shape, or contour of the protrusion 415. The profile of the protrusion 415 can cause the deformation 435 of the patterned surface 120 of the electrode foil 110 to have a shape (e.g., curvature, profile, geometry) corresponding to the profile of the protrusion 415. For example, a profile having a sharp or blunt point (e.g., a triangular profile) can cause the patterned surface 120 of the electrode foil 110 to include a sharp or blunt deformation 435. The protrusion 415 can include a circular or semi-circular profile 700 as depicted in FIG. 7, among others. The profile 700 of the protrusion 415 can deform the electrode foil 110 to create the patterned surface 120 having a circular or semi-circular deformation 435. The protrusion 415 can include a triangular profile 800 as depicted in FIG. 8, among others. The profile 800 of the protrusion 415 can deform the electrode foil 110 to create the patterned surface 120 having a V-shaped deformation 435 or some other sharp or blunt deformation 435. The protrusion 415 can include a square or rectangular profile 900 as depicted in FIG. 9, among others. The profile 900 of the protrusion 415 can deform the electrode foil 110 to create the patterned surface 120 having a square or rectangular deformation 435. The protrusion 415 can include a semi-rounded, semi-square, or semi-rectangular profile 1000, as depicted in FIG. 10, among others. The profile 1000 of the protrusion 415 can deform the electrode foil 110 to create the patterned surface 120 having a semi-rounded, semi-square, or semi-rectangular deformation 435. For example, the deformation 435 can include a flat bottom and rounded edges. The protrusion 415 can include a trapezoidal profile 1100 as depicted in FIG. 11, among others. The profile 1100 of the protrusion 415 can deform the electrode foil 110 to create the patterned surface 120 having a trapezoidal deformation 435. The protrusion 415 can include some other profile, such as a star-shaped profile, a zig-zag profile, a notched profile, a parabolic profile, an oval profile, or some other profile. Regardless of the shape or geometry of the profile, the profile of the protrusion 415 can deform the electrode foil 110 to create the patterned surface 120 having a corresponding deformation 435. The system 125 can include the patterned surface 140 including the patterned element 135 having at least one depression 420, the depression 420 including one or more of the profiles 700-1100.

The system 125 can include the patterned surface 140 of the patterned element 135 having a first protrusion 415 and a second protrusion 415, the first protrusion including a first profile and the second protrusion including a second profile. The first profile and the second profile can be different. For example, the first protrusion 415 can include a semi-circular profile (e.g., the profile 700), and the second protrusion 415 can include a trapezoidal profile (e.g., the profile 1100). The profile of the first protrusion 415 can cause the deformation 435 of the patterned surface 120 of the electrode foil 110 to have a shape (e.g., curvature, profile, geometry) corresponding to the profile of the first protrusion 415. The profile of the second protrusion 415 can cause the deformation 435 of the patterned surface 120 of the electrode foil 110 to have a shape (e.g., curvature, profile, geometry) corresponding to the profile of the second protrusion 415. The patterned surface 120 of the electrode foil 110 can include at least one deformation 435 having a rounded or semi-circular shape corresponding to the first protrusion 415 with the first profile and at least one deformation 435 having a trapezoidal shape corresponding to the second protrusion 415 with the second profile. The patterned surface 140 of the patterned element 135 having multiple protrusions 415, the multiple protrusions 415 collectively including more than two different profiles (e.g., 3, 5, 10, or some other number) of different profiles.

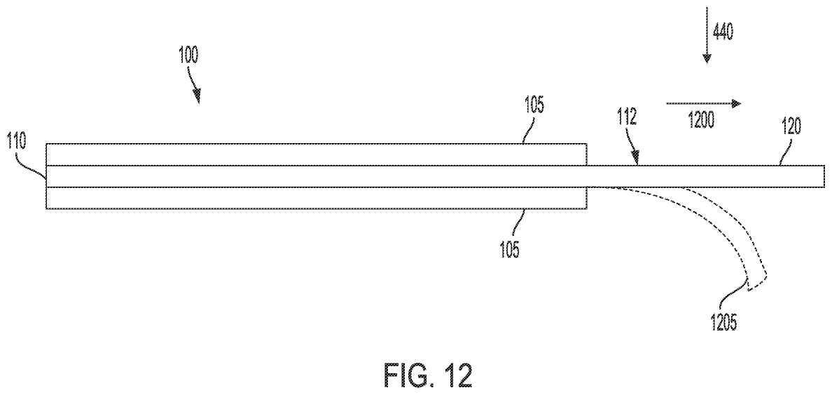

FIG. 12, among others, depicts the electrode 100 having the uncoated portion 112 of the electrode foil 110 including the patterned surface 120. The patterned surface 120 of the uncoated portion 112 of the electrode foil 110 can increase a bending stiffness of the uncoated portion 112 such that the uncoated portion 112 does not bend (e.g., flop, sag, dip, droop, crease, fold). For example, the uncoated portion 112 of the electrode foil 110 can include an increased bending stiffness such that the uncoated portion 112 does not bend under a gravitational force or some other force introduced or imposed upon the uncoated portion 112 (or the electrode 100 more generally) via motion of the electrode 100 during manufacturing (e.g., as the electrode web 100 moves from a notching station to a slitting station). A gravitational force or some other force imposed upon the uncoated portion 112 can act in the direction 440. The patterned surface 120 of the uncoated portion 112 can increase a bending stiffness of the uncoated portion 112 such that the uncoated portion 112 does not bend under a gravitational force or some other force. For example, the uncoated portion 112 can extend from the electrode foil 110 (e.g., from a coated portion of the electrode foil) in a direction 1200 (e.g., in a direction parallel with an outer surface of the battery active material layer 105). The direction 1200 can be perpendicular to the direction 440 in which a force (e.g., a gravitational force) acts upon the uncoated portion 112. The increased bending stiffness of the uncoated portion 112 of the electrode foil 110 having the patterned surface 120 can retain (e.g., hold, stabilize, keep) the uncoated portion 112 in the direction 1200 such that the uncoated portion does not bend despite forces imposed upon the uncoated portion 112. For example, an uncoated portion 112 without the patterned surface 120, shown in phantom line as 1205 in FIG. 12, can have a relatively lower bending stiffness such that the uncoated portion 1205 undesirably bends (e.g., flops, sags, dips, droops, creases, folds) in the direction 440 or some other direction when subject to forces (e.g., a gravitational force). Because the uncoated portion 1205 bends, it can be creased, folded, or otherwise damaged during manufacturing operations. The uncoated portion 1205 can further cause challenges welding a tab of the uncoated portion 1205 with additional tabs with the uncoated portion 1205 bent or damaged.

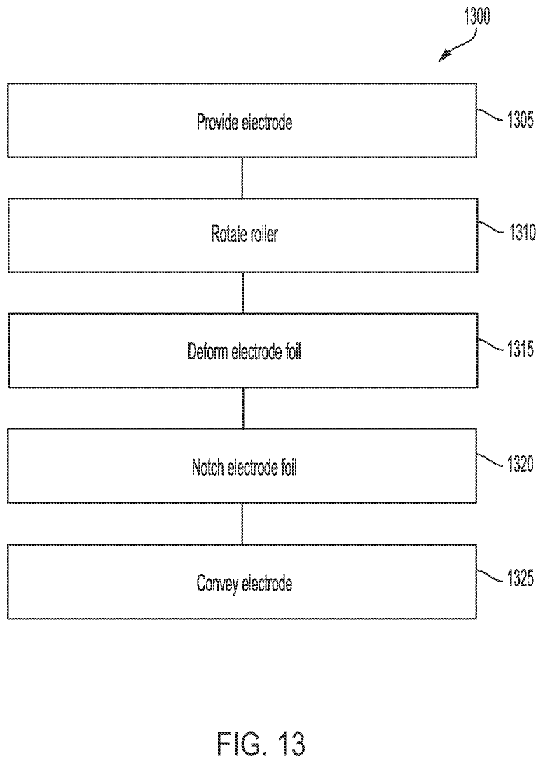

FIG. 13 depicts a flow chart of a method 1300. The method 1300 can be a method of manufacturing an electrode or an electrode web (e.g., the electrode web 100). For example, the method 1300 can be a method of manufacturing the electrode web 100 with the system 125. The method 1300 can include one or more of ACTS 1305-1325. The ACTS 1305-1325 can be performed in the order depicted in FIG. 13 or in some other order.

The method 1300 can include providing an electrode at ACT 1305. For example, the method 1300 can include providing the electrode web 100 to the system 125 at ACT 1305. The system 125 can include the roller 130 having the patterned element 135 with the patterned surface 140. The patterned surface 140 of the patterned element 135 can contact the uncoated portion 112 of the electrode web 100 and apply a force or pressure to the uncoated portion. The patterned element 135 can include the protrusion 415 and the depression 420. The patterned element 135 and the roller 130 can rotate about the axis 145 in the direction 425. The system 125 can include a second surface, such as the second surface 335 of the second roller 330. The patterned element 135 can apply a pressure to the uncoated portion 112 of the electrode web 100 to deform the uncoated portion 112 with the uncoated portion 112 positioned between the patterned element 135 and the second surface 335. The second surface 335 a can be a surface of the second roller 330 or, a flat surface, a curved surface, an arcuate surface, or some other surface. The electrode web 100 can be provided at least partially between the patterned element 135 and the second surface 335. For example, the electrode web 100 can be at least partially received in the nip 410 formed by the first roller 130 and the second roller 330 such the uncoated portion 112 can be positioned between the patterned element 135 and the second surface 335.

The method 1300 can include rotating a roller at ACT 1310. For example, the method 1300 can include rotating the first roller 130 in the direction 425 at ACT 1310. The first roller 130 can rotate in the direction 425 with the electrode web 100 positioned within the nip 410 between the first roller 130 and the second roller 330. For example, the first roller 130 can rotate with the uncoated portion 112 of the electrode web 100 at least partially positioned between the patterned element 135 and the second surface 335. The patterned element 135 can contact the uncoated portion 112 as the roller rotates in the direction 425. For example, the patterned element 135 can rotate against the uncoated portion 112 as the uncoated portion 112 moves in the direction 150 between the patterned element 135 and the second surface (e.g., the second surface 335 of the second roller 330).

The method 1300 can include deforming an electrode foil at ACT 1315. For example, the method 1300 can include deforming the uncoated portion 112 of the electrode foil 110 with the patterned surface 140 of the patterned element 135 at ACT 1315. The patterned surface 140 of the patterned element 135 can contact the uncoated portion 112 of an electrode web 100 and apply a force or pressure to the uncoated portion 112 as the roller 130 rotates in the direction 425 at ACT 1310. The patterned surface 140 of the patterned element 135 can deform the uncoated portion 112 with the uncoated portion 112 at least partially positioned between the patterned element 135 and the second surface (e.g., the second surface 335 of the second roller 330) to create at least one deformation 435 of the uncoated portion 112. For example, the uncoated portion 112 of the electrode foil 110 can be malleable and bendable such that the uncoated portion 112 can bend or deform when subject to pressure from the patterned element 135. The patterned element 135 can deform the uncoated portion 112 to create the patterned surface 120 of the uncoated portion 112. The patterned surface 120 can include multiple deformations 435 corresponding to the protrusions 415 and depressions 420 of the patterned element 135 or corresponding to some protrusion, surface texture, or other feature of the second surface.

The method 1300 can include notching an electrode foil at ACT 1320. For example, the method 1300 can include notching the uncoated portion 112 of the electrode foil 110 via the notching device 525 at ACT 1320. The notching device 525 can include the first roller 530 and the second roller 535 positioned adjacent to each other to form the nip 540. The nip 540 can receive the electrode web 100. For example, the nip 540 can receive the electrode web 100 prior to or after the system 125 has deformed the uncoated portion 112 of the electrode foil 110 at ACT 1315. The electrode web 100 can move in the first direction 150 between the first roller 530 and the second roller 535 such that the electrode web 100 moves in the first direction 150 at least partially through the nip 540. The first roller 530 or the second roller 535 can include a blade, knife, or other sharp object that can contact the uncoated portion 112 of the electrode foil 110 to cut the uncoated portion 112. The blade can cut through the uncoated portion 112 to create the electrode tab 200. The notching device 525 can cut away a remaining (e.g., unwanted, scrap) portion of the uncoated portion 112 to leave multiple electrode tabs 200. For example, the notching device 525 can remove a scrap portion of the uncoated portion 112 or cause a scrap portion of the uncoated portion 112 to be removed from the electrode foil 110 such that the electrode tab 200 remains, but other portions of the uncoated portion 112 are removed. The blade of the notching device 525 can be coupled with the first roller 530 and can contact (e.g., press against) the second roller 535 to cut the uncoated portion 112 of the electrode foil 110. The notching device 525 can include at least one laser device to notch the electrode foil 110. For example, the notching device 525 can be or include a laser cutter configured to emit a beam at the uncoated portion 112. The beam can melt or otherwise cut through the uncoated portion 112 to notch the electrode tab 200 from the uncoated portion 112. The notching device 525 can be positioned upstream from (e.g., prior to) or downstream from (e.g., subsequent to) the system 125 to deform the uncoated portion 112.

The method 1300 can include conveying an electrode at ACT 1325. For example, the method 1300 can include conveying the electrode web 100 with the uncoated portion 112 of the electrode foil 110 including the patterned surface 120. The deformation 435 or multiple deformations 435 forming the patterned surface 120 can increase a bending stiffness of the uncoated portion 112 or can alter an area moment of inertia of the uncoated portion 112 to improve a rigidity of the uncoated portion 112. For example, the uncoated portion 112 can be less susceptible to bending, creasing, folding, or other damage as the electrode web 100 is processed to manufacture electrodes. For example, the uncoated portion can be subject to gravitational forces (e.g., forces acting in the direction 440), among others, during manufacture of an electrode web or an electrode, where the forces can cause the uncoated portion to sag, bend, hang, droop, or otherwise flex, which can lead to the uncoated portion becoming inadvertently creased, folded, crimped, or damaged. The electrode web 100 can be conveyed via one or more web handling devices 545 or some other device with the uncoated portion 112 substantially (e.g., 95%) prevented from bending, creasing, folding, crimping, during conveyance of the electrode web 100.

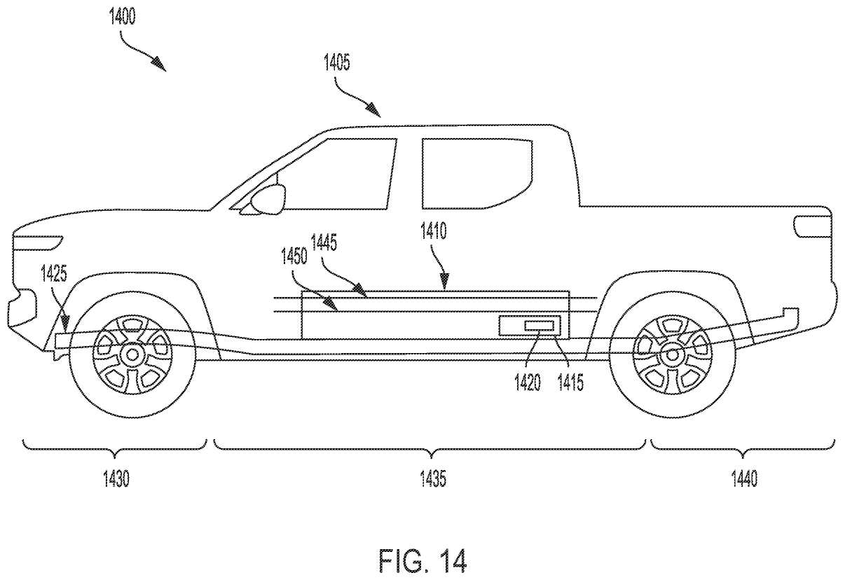

FIG. 14 depicts an example cross-sectional view 1400 of an electric vehicle 1405 installed with at least one battery pack 1410. Electric vehicles 1405 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 1410 can also be used as an energy storage system to power a building, such as a residential home or commercial building. Electric vehicles 1405 can be fully electric or partially electric (e.g., plug-in hybrid) and further, electric vehicles 1405 can be fully autonomous, partially autonomous, or unmanned. Electric vehicles 1405 can also be human operated or non-autonomous. Electric vehicles 1405 such as electric trucks or automobiles can include on-board battery packs 1410, batteries 1415 or battery modules 1415, or battery cells 1420 to power the electric vehicles. The electric vehicle 1405 can include a chassis 1425 (e.g., a frame, internal frame, or support structure). The chassis 1425 can support various components of the electric vehicle 1405. The chassis 1425 can span a front portion 1430 (e.g., a hood or bonnet portion), a body portion 1435, and a rear portion 1440 (e.g., a trunk, payload, or boot portion) of the electric vehicle 1405. The battery pack 1410 can be installed or placed within the electric vehicle 1405. For example, the battery pack 1410 can be installed on the chassis 1425 of the electric vehicle 1405 within one or more of the front portion 1430, the body portion 1435, or the rear portion 1440. The battery pack 1410 can include or connect with at least one busbar, e.g., a current collector element. For example, the first busbar 1445 and the second busbar 1450 can include electrically conductive material to connect or otherwise electrically couple the battery 1415, the battery modules 1415, or the battery cells 1420 with other electrical components of the electric vehicle 1405 to provide electrical power to various systems or components of the electric vehicle 1405.

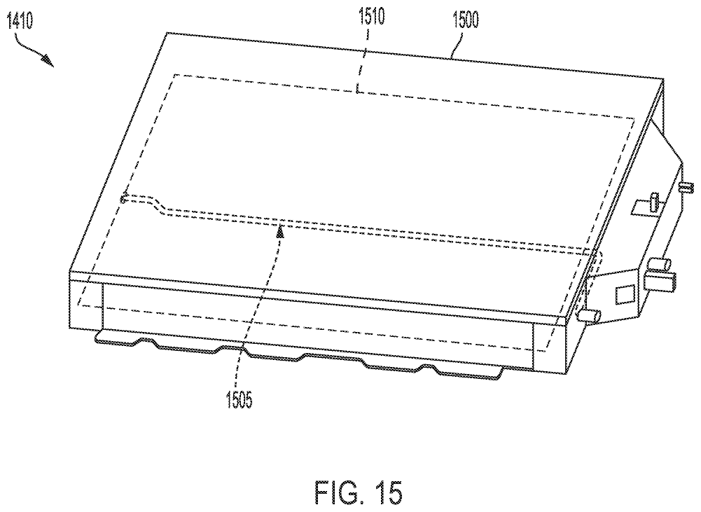

FIG. 15 depicts an example battery pack 1410. Referring to FIG. 15, among others, the battery pack 1410 can provide power to electric vehicle 1405. Battery packs 1410 can include any arrangement or network of electrical, electronic, mechanical or electromechanical devices to power a vehicle of any type, such as the electric vehicle 1405. The battery pack 1410 can include at least one housing 1500. The housing 1500 can include at least one battery module 1415 or at least one battery cell 1420, as well as other battery pack components. The battery module 1415 can be or can include one or more groups of prismatic cells, cylindrical cells, pouch cells, or other form factors of battery cells 1420. The housing 1500 can include a shield on the bottom or underneath the battery module 1415 to protect the battery module 1415 and/or cells 1420 from external conditions, for example if the electric vehicle 1405 is driven over rough terrains (e.g., off-road, trenches, rocks, etc.) The battery pack 1410 can include at least one cooling line 1505 that can distribute fluid through the battery pack 1410 as part of a thermal/temperature control or heat exchange system that can also include at least one thermal component (e.g., cold plate) 1510. The thermal component 1510 can be positioned in relation to a top submodule and a bottom submodule, such as in between the top and bottom submodules, among other possibilities. The battery pack 1410 can include any number of thermal components 1510. For example, there can be one or more thermal components 1510 per battery pack 1410, or per battery module 1415. At least one cooling line 1505 can be coupled with, part of, or independent from the thermal component 1510.

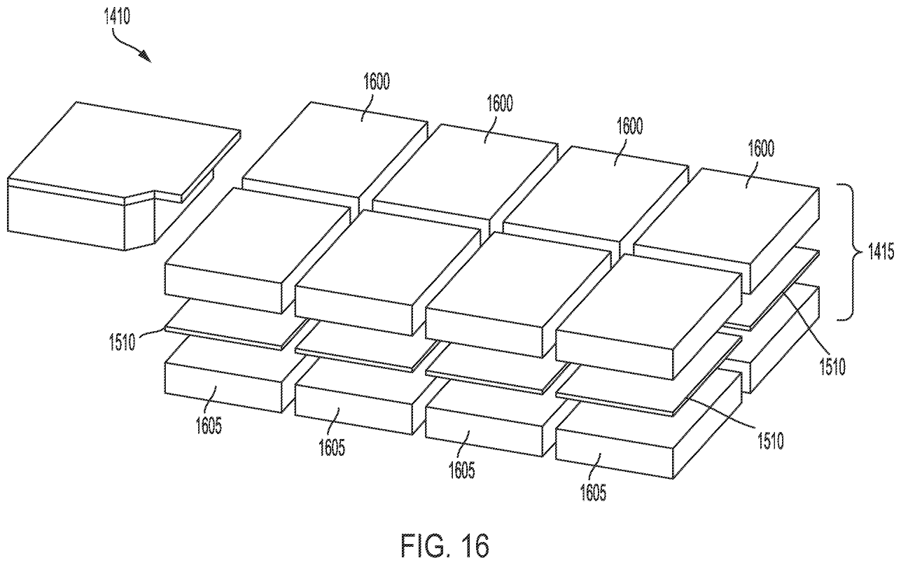

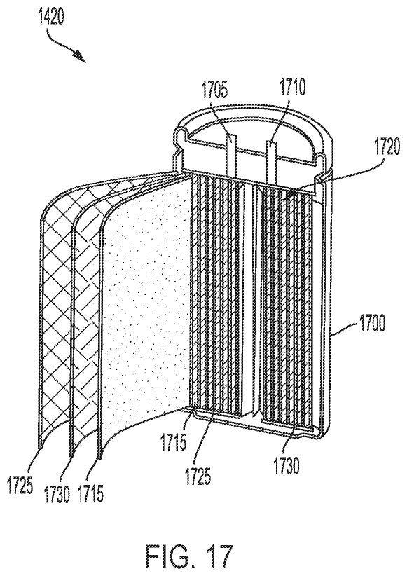

FIG. 16 depicts example battery modules 1415, and FIGS. 17, 18 and 19 depict an example cross sectional view of a battery cell 1420. The battery modules 1415 can include at least one submodule. For example, the battery modules 1415 can include at least one first (e.g., top) submodule 1600 or at least one second (e.g., bottom) submodule 1605. At least one thermal component 1510 can be disposed between the top submodule 1600 and the bottom submodule 1605. For example, one thermal component 1510 can be configured for heat exchange with one battery module 1415. The thermal component 1510 can be disposed or thermally coupled between the top submodule 1600 and the bottom submodule 1605. One thermal component 1510 can also be thermally coupled with more than one battery module 1415 (or more than two submodules 1600, 1605). The thermal components 1510 shown adjacent to each other can be combined into a single thermal component 1510 that spans the size of one or more submodules 1600 or 1605. The thermal component 1510 can be positioned underneath submodule 1600 and over submodule 1605, in between submodules 1600 and 1605, on one or more sides of submodules 1600, 1605, among other possibilities. The thermal component 1510 can be disposed in sidewalls, cross members, structural beams, among various other components of the battery pack, such as battery pack 1410 described above. The battery submodules 1600, 1605 can collectively form one battery module 1415. In some examples each submodule 1600, 1605 can be considered as a complete battery module 1415, rather than a submodule.

The battery modules 1415 can each include a plurality of battery cells 1420. The battery modules 1415 can be disposed within the housing 1500 of the battery pack 1410. The battery modules 1415 can include battery cells 1420 that are cylindrical cells or prismatic cells, for example. The battery module 1415 can operate as a modular unit of battery cells 1420. For example, a battery module 1415 can collect current or electrical power from the battery cells 1420 that are included in the battery module 1415 and can provide the current or electrical power as output from the battery pack 1410. The battery pack 1410 can include any number of battery modules 1415. For example, the battery pack can have one, two, three, four, five, six, seven, eight, nine, ten, eleven, twelve or other number of battery modules 1415 disposed in the housing 1500. It should also be noted that each battery module 1415 may include a top submodule 1600 and a bottom submodule 1605, possibly with a thermal component 1510 in between the top submodule 1600 and the bottom submodule 1605. The battery pack 1410 can include or define a plurality of areas for positioning of the battery module 1415 and/or cells 1420. The battery modules 1415 can be square, rectangular, circular, triangular, symmetrical, or asymmetrical. In some examples, battery modules 1415 may be different shapes, such that some battery modules 1415 are rectangular but other battery modules 1415 are square shaped, among other possibilities. The battery module 1415 can include or define a plurality of slots, holders, or containers for a plurality of battery cells 1420. It should be noted the illustrations and descriptions herein are provided for example purposes and should not be interpreted as limiting. For example, the battery cells 1420 can be inserted in the battery pack 1410 without battery modules 1600 and 1605. The battery cells 1420 can be disposed in the battery pack 1410 in a cell-to-pack configuration without modules 1600 and 1605, among other possibilities.

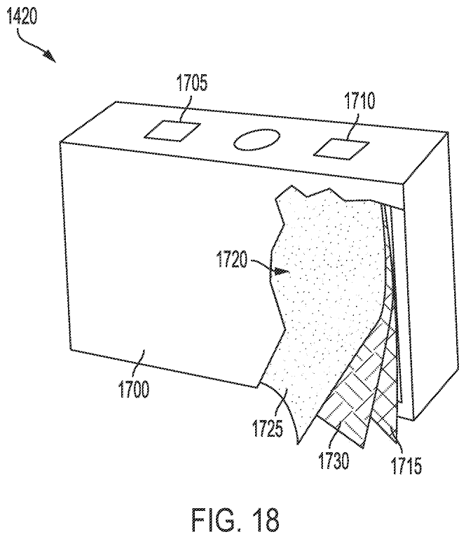

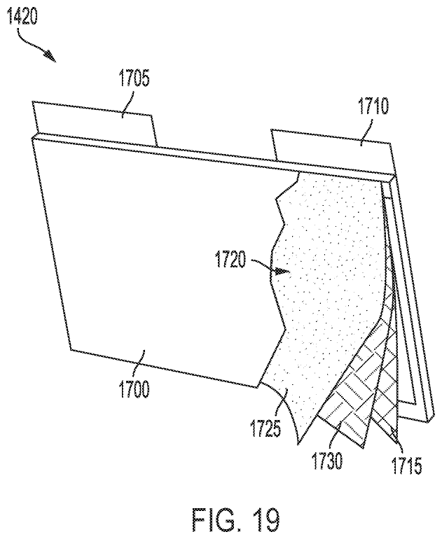

Battery cells 1420 have a variety of form factors, shapes, or sizes. For example, battery cells 1420 can have a cylindrical, rectangular, square, cubic, flat, pouch, elongated or prismatic form factor. As depicted in FIG. 17, for example, the battery cell 1420 can be cylindrical. As depicted in FIG. 18 for example, the battery cell 1420 can be prismatic. As depicted in FIG. 19, for example, the battery cell 1420 can include a pouch form factor. Battery cells 1420 can be assembled, for example, by inserting a winded or stacked electrode roll (e.g., a jelly roll) including electrolyte material into at least one battery cell housing 1700. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 1420 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 1420. The housing 1700 can be of various shapes, including cylindrical or rectangular, for example. Electrical connections can be made between the electrolyte material and components of the battery cell 1420. For example, electrical connections to the electrodes with at least some of the electrolyte material can be formed at two points or areas of the battery cell 1420, for example to form a first polarity terminal 1705 (e.g., a positive or anode terminal) and a second polarity terminal 1710 (e.g., a negative or cathode terminal). The polarity terminals can be made from electrically conductive materials to carry electrical current from the battery cell 1420 to an electrical load, such as a component or system of the electric vehicle 1405.

For example, the battery cell 1420 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 1420 to separate the anode and cathode from each other and to facilitate transfer of lithium ions between the anode and cathode. It should be noted that battery cell 1420 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr. La, and B=Al, Ti), garnet-type with formula A₃B₂(XO₄)₃(A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₂P₃S₁₁, Li₂S—P₂S₅, Li₂S—B₂S₃, SnS—P₂S₅, Li₂S—SiS₂, Li₂S—P₂S₅, Li₂S—GeS₂, LinoGeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 1420 can be included in battery modules 1415 or battery packs 1410 to power components of the electric vehicle 1405. The battery cell housing 1700 can be disposed in the battery module 1415, the battery pack 1410, or a battery array installed in the electric vehicle 1405. The housing 1700 can be of any shape, such as cylindrical with a circular (e.g., as depicted in FIG. 17, among others), elliptical, or ovular base, among others. The shape of the housing 1700 can also be prismatic with a polygonal base, as shown in FIG. 18, among others. As shown in FIG. 19, among others, the housing 1700 can include a pouch form factor. The housing 1700 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 1700 of the battery cell 1420 can include one or more materials with various electrical conductivity or thermal conductivity, or a combination thereof. The electrically conductive and thermally conductive material for the housing 1700 of the battery cell 1420 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 1700 of the battery cell 1420 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 1700 of the battery cell 1420 is prismatic (e.g., as depicted in FIG. 18, among others) or cylindrical (e.g., as depicted in FIG. 17, among others), the housing 1700 can include a rigid or semi-rigid material such that the housing 1700 is rigid or semi-rigid (e.g., not easily deformed or manipulated into another shape or form factor). In examples where the housing 1700 includes a pouch form factor (e.g., as depicted in FIG. 19, among others), the housing 1700 can include a flexible, malleable, or non-rigid material such that the housing 1700 can be bent, deformed, manipulated into another form factor or shape.

The battery cell 1420 can include the electrode web 100. The electrode can be least one anode layer 1715, which can be disposed within the cavity 1720 defined by the housing 1700. The anode layer 1715 can include a first redox potential. The anode layer 1715 can receive electrical current into the battery cell 1420 and output electrons during the operation of the battery cell 1420 (e.g., charging or discharging of the battery cell 1420). The anode layer 1715 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg. Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 1420 can include the electrode web 100. The electrode web 100 can include at least one cathode layer 1725 (e.g., a composite cathode layer compound cathode layer, a compound cathode, a composite cathode, or a cathode). The cathode layer 1725 can include a second redox potential that can be different than the first redox potential of the anode layer 1715. The cathode layer 1725 can be disposed within the cavity 1720. The cathode layer 1725 can output electrical current out from the battery cell 1420 and can receive electrons during the discharging of the battery cell 1420. The cathode layer 1725 can also receive lithium ions during the discharging of the battery cell 1420. Conversely, the cathode layer 1725 can receive electrical current into the battery cell 1420 and can output electrons during the charging of the battery cell 1420. The cathode layer 1725 can release lithium ions during the charging of the battery cell 1420.

The battery cell 1420 can include a layer 1730 disposed within the cavity 1720. The layer 1730 can include a solid electrolyte layer. The layer 1730 can include a separator wetted by a liquid electrolyte. The layer 1730 can include a polymeric material. The layer 1730 can include a polymer separator. The layer 1730 can be arranged between the anode layer 1715 and the cathode layer 1725 to separate the anode layer 1715 and the cathode layer 1725. The polymer separator can physically separate the anode and cathode from a cell short circuit. A separator can be wetted with a liquid electrolyte. The liquid electrolyte can be diffused into the anode layer 1715. The liquid electrolyte can be diffused into the cathode layer 1725. The layer 1730 can help transfer ions (e.g., Li⁺ ions) between the anode layer 1715 and the cathode layer 1725. The layer 1730 can transfer Li⁺ cations from the anode layer 1715 to the cathode layer 1725 during the discharge operation of the battery cell 1420. The layer 1730 can transfer lithium ions from the cathode layer 1725 to the anode layer 1715 during the charge operation of the battery cell 1420.

The redox potential of layers (e.g., the first redox potential of the anode layer 1715 or the second redox potential of the cathode layer 1725) can vary based on a chemistry of the respective layer or a chemistry of the battery cell 1420. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 1725). Lithium-ion batteries can include a graphite chemistry, a silicon-graphite chemistry, or a lithium metal chemistry for the anode layer (e.g., the anode layer 1715).

For example, lithium-ion batteries can include an olivine phosphate (LiMPO₄, M=Fc and/or Co and/or Mn and/or Ni)) chemistry, LISICON or NASICON Phosphates (Li₃M₂(PO₄)₃ and LIMPO₄Oₓ, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fc, Co, Ni) and Fluorosulfates LiMSO₄F (M=Co, Ni, Mn) (e.g., the cathode layer 1725). Lithium-ion batteries can include a graphite chemistry, a silicon-graphite chemistry, or a lithium metal chemistry for the anode layer (e.g., the anode layer 1715). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 1725) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 1715) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The layer 1730 can include or be made of a liquid electrolyte material. For example, the layer 1730 can be or include at least one layer of polymeric material (e.g., polypropylene, polyethylene, or other material) including pores that are wetted (e.g., saturated with, soaked with, receive, are filled with) a liquid electrolyte substance to enable ions to move between electrodes. The liquid electrolyte material can include a lithium salt dissolved in a solvent. The lithium salt for the liquid electrolyte material for the layer 1730 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. Liquid electrolyte is not necessarily disposed near the layer 1730, but the liquid electrolyte can fill the battery cells 1420 in many different ways. The layer 1730 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr. La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₂P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the layer 1730 includes a liquid electrolyte material, the layer 1730 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The layer 1730 can include at least one additive. The additives can be or include vinylidene carbonate, fluoroethylene carbonate, ethyl propionate, methyl propionate, methyl acetate, ethyl acetate, or a mixture of any two or more thereof. The layer 1730 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the layer 1730 from greater than 0 M to about 1.5 M. Once disposed to the battery cell 1420, liquid electrolyte can be present and touching battery subcomponents present within the battery cell 1420. The battery subcomponents can include the cathode, the anode, the separator, the current collector, etc.

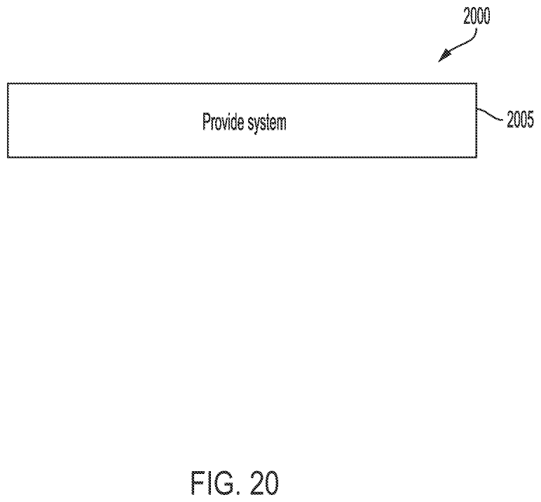

FIG. 20, among others, depicts a method 2000. The method 2000 can include providing a system at ACT 2005. The system can be the system 125. The system 125 can include the roller 130 having the patterned element 135 with the patterned surface 140. The patterned surface 140 of the patterned element 135 can contact the uncoated portion 112 of the electrode web 100 and apply a force or pressure to the uncoated portion. The patterned element 135 can include the protrusion 415 and the depression 420. The patterned element 135 and the roller 130 can rotate about the axis 145 in the direction 425. The system 125 can include a second surface, such as the second surface 335 of the second roller 330. The patterned element 135 can apply a pressure to the uncoated portion 112 of the electrode web 100 to deform the uncoated portion 112 with the uncoated portion 112 positioned between the patterned element 135 and the second surface 335. The second surface 335 a can be a surface of the second roller 330 or, a flat surface, a curved surface, an arcuate surface, or some other surface. The electrode web 100 can be provided at least partially between the patterned element 135 and the second surface 335. For example, the electrode web 100 can be at least partially received in the nip 410 formed by the first roller 130 and the second roller 330 such the uncoated portion 112 can be positioned between the patterned element 135 and the second surface 335.

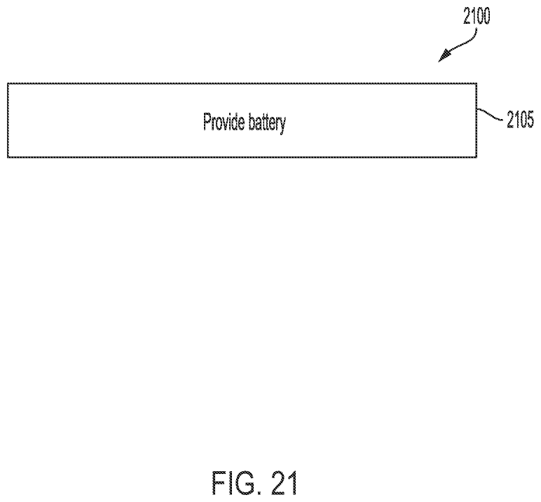

FIG. 21, among others, depicts a method 2100. The method 2100 can include providing a battery at ACT 2105. For example, the method 2100 can include providing a battery having one or more electrodes manufactured from the electrode web 100. The electrode web 100 can include the uncoated portion 112. The uncoated portion 112 can include the patterned surface 120. The patterned surface 120 can be or include one or more deformations 435. The deformations 435 can be linear, non-linear, or of some other shape, profile, size, depth, or length. The deformations 435 can be oriented at an angle with respect to an edge of the uncoated portion 112 or an edge of the battery active material layer 105 applied to the electrode foil 110. The uncoated portion 112 can include the patterned surface 120 to increase a bending stiffness or an area moment of inertia of the uncoated portion 112. The increased bending stiffness or area moment of inertia of the uncoated portion 112 can substantially (e.g., ±95%) prevent the uncoated portion 112 from bending, folding, creasing, crimping, or being otherwise damaged during manufacture of an electrode from the electrode web 100.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a first roller including a first surface comprising a pattern to form a patterned surface on an uncoated portion of an electrode foil; and
the first roller to deform the uncoated portion of the electrode foil to create the patterned surface on the uncoated portion of the electrode foil.

2. The system of claim 1, wherein the patterned surface on the uncoated portion of the electrode foil increases a bending stiffness of the uncoated portion to prevent bending of the uncoated portion of the electrode foil.

3. The system of claim 1, comprising:
the pattern of the first surface including a protrusion, the protrusion to create a deformation of the patterned surface, the deformation oriented at an angle relative to an edge of the uncoated portion of the electrode foil, wherein the angle is greater than or equal to 10 degrees and less than or equal to 90 degrees.

4. The system of claim 1, comprising:
the pattern of the first surface including a protrusion create a deformation of the patterned surface, the protrusion based on a shape corresponding to at least one of a triangle, circle, trapezoid, rectangle, or curve.

5. The system of claim 1, comprising:
the pattern of the first surface including a first protrusion and a second protrusion, the first protrusion including a first profile that differs from a second profile of the second protrusion; and
the first protrusion to create a first deformation of the patterned surface and the second protrusion to create a second deformation of the patterned surface, the first deformation including the first profile, the second deformation including the second profile.

6. The system of claim 1, comprising:
a second roller comprising a second surface, the second roller; and
the electrode foil to move in a first direction between the first surface of the first roller and the second surface of the second roller with the first roller and the second roller rotating.

7. The system of claim 1, comprising:
a second roller comprising a second surface, the second surface including a second pattern; and
the first roller and the second roller to deform the uncoated portion of the electrode foil to create the patterned surface with the first surface of the first roller contacting a first side of the uncoated portion of the electrode foil and the second surface of the second roller contacting a second side of the uncoated portion of the electrode foil.

8. The system of claim 1, comprising:
a second roller comprising a second surface, the second surface including a second pattern; and
the pattern of the first surface of the first roller including a first protrusion, the first protrusion to deform the uncoated portion of the electrode foil in a first direction; and
the second pattern of the second surface of the second roller including a second protrusion, the second protrusion to deform the uncoated portion of the electrode foil in a second direction.

9. The system of claim 1, comprising:
a second surface comprising a second pattern,
the pattern of the first surface of the first roller to engage with the second pattern of the second surface to deform the electrode foil with the uncoated portion of the electrode foil disposed between the first surface and the second surface.

10. The system of claim 1, comprising:
a second roller defining a second surface, the second surface including a second pattern;
the pattern of the first surface of the first roller including a first protrusion and a second protrusion, the first protrusion create a first deformation of the uncoated portion of the electrode foil, the second protrusion to create a second deformation of the uncoated portion of the electrode foil, the first deformation and the second deformation extending in a first direction; and
the second pattern of the second surface including a third protrusion.

11. The system of claim 1, comprising:
a second surface comprising a malleable material; and
the pattern of the first surface of the first roller including a protrusion to depress the second surface with the first surface of the first roller contacting the uncoated portion of the electrode foil.

12. The system of claim 1, comprising:
a notching device to cut the uncoated portion of the electrode foil to create an electrode tab from the uncoated portion, the electrode tab having the patterned surface.

13. The system of claim 1, wherein the uncoated portion of the electrode foil includes a first uncoated portion and a second uncoated portion, the system comprising:
a second surface;
a notching device to cut the electrode foil remove the second uncoated portion; and
the first roller to deform the first uncoated portion to create the patterned surface on the first uncoated portion with at least the first uncoated portion disposed between the first surface of the first roller and the second surface.

14. A method, comprising:
providing a battery electrode foil comprising a coated portion and an uncoated portion to a first surface comprising a pattern to form a patterned surface on the uncoated portion of the battery electrode foil;
deforming at least a portion of the uncoated portion of the battery electrode foil to create the patterned surface on the uncoated portion of the battery electrode foil; and
notching, by a notching device, the at least the portion of the uncoated portion of the battery electrode foil to form a plurality of tabs on the uncoated portion of the battery electrode foil.

15. The method of claim 14, wherein deforming the uncoated portion of the battery electrode foil comprises deforming the uncoated portion of the battery electrode foil with the uncoated portion of the battery electrode foil at least partially disposed between the first surface and a second surface.

16. The method of claim 14, wherein the first surface is the first surface of a first roller, the first surface comprising a first pattern, and
wherein deforming the uncoated portion of the battery electrode foil comprises deforming, by the first roller, the uncoated portion of the battery electrode foil with the uncoated portion of the battery electrode foil at least partially disposed between the first surface and a second surface.

17. The method of claim 14, comprising:
conveying, by at least one web handling device, the battery electrode foil to a subsequent device with the plurality of tabs including the patterned surface prevent bending of the plurality of tabs.

18. The method of claim 14, wherein the first surface is the first surface of a first roller, wherein the battery electrode foil moves in a first direction between the first surface and a second surface, the first roller to rotate in a second direction to deform the uncoated portion of the battery electrode foil.

19. A battery, comprising:
one or more cells comprising one or more tabs formed from an uncoated portion of an electrode foil, wherein the one or more tabs include a surface having a pattern to increase a bending stiffness of the one or more tabs relative to a coated portion of the electrode foil.

20. The battery of claim 19, comprising:
the one or more tabs extending from the coated portion of the electrode foil in a first direction; and
the pattern of the surface to increase the bending stiffness of the one or more tabs with the one or more tabs notched from the electrode foil such that the one or more tabs are retained in the first direction.
